(19) United States
(12) Patent Application Publication
(10) Pub. No.: US 2018/0016936 A1
(43) Pub. Date: Jan. 18, 2018

(54) DEVICE AND METHOD FOR SERVICE-LIFE MONITORING

(71) Applicant: MTU Aero Engines AG, Muenchen (DE)

(72) Inventors: Eberhard Knodel, Jetzendorf-Priel (DE); Hans-Peter Borufka, Starnberg (DE); Hernan Victor Arrieta, Rzeszow (PL)

(21) Appl. No.: 15/717,566

(22) Filed: Sep. 27, 2017

Related U.S. Application Data
(63) Continuation of application No. 12/998,054, filed on Mar. 11, 2011, now abandoned.

(30) Foreign Application Priority Data
Sep. 26, 2008 (DE) 10 2008 049 170.5

(51) Int. Cl. F01D 21/00

(52) U.S. Cl. CPC F01D 21/003; F05D 2270/11; Y02T 50/671

(57) ABSTRACT

In the case of a device and a method for monitoring the service life of an engine or of a turbine having a compressor blisk and/or a turbine blisk, momentary stresses of blisk substructures, such as the blade (1), the disk (2), and the join region (3) between the blade (1) and the disk (2), are calculated on the basis of operating parameters that are measured in the course of engine or turbine operation; and accumulated damage to the individual substructures, that was caused by the momentary stresses, is estimated.

This is a Continuation of U.S. patent application Ser. No. 12/998,054, filed on Mar. 11, 2011 as National Phase Application of International Patent Application PCT/DE2009/001282, filed Sep. 9, 2009 which claims the benefit of German Patent Application DE10 2008 049 170.5, filed Sep. 26, 2008. All of the above applications are hereby incorporated by reference herein.

The present invention relates to a device and a method for monitoring the service life of engines or turbines having a compressor blisk and/or a turbine blisk.

Aircraft engines and stationary turbines must regularly undergo maintenance and be examined for any damage that occurred during operation. This regular monitoring can be supplemented by a service-life monitoring during operation in order to estimate in advance the stress level and the damage condition of the engine or the turbine and to facilitate a condition-based maintenance.

### BACKGROUND

Such an on-board, service-life monitoring of aircraft engines during operation has been known for quite some time and was developed by the Applicant for the RB199 jet engines of the Tornado and EJ200 of the Eurofighter and the MTR390 turboshaft engine of the Tiger helicopter. This service-life monitoring employs different algorithms in order to calculate the momentary stresses of critical engine components on the basis of operating parameters that are measured during operation of the engine. The accumulated damage to the engine component, that is caused by the momentary stresses, is subsequently estimated, and the service life that has been consumed to that point is ascertained.

Compressor blisks and turbine blisks are used in modern engines. The word ‘blisk’ is an abbreviated form in English of “blade integrated disk,” which is composed of the words ‘blade’ and ‘disk.’ As the word indicates, in the case of one blisk, the blade and disk form one unit. This eliminates the need for assembly costs, and a weight reduction is achieved.

Blisks can be manufactured by machining the blade profile from the outer contour of a forged disk or of a disk segment, or by permanently joining a blade, for example, by friction welding, to a disk or a disk segment. The enclosed drawing shows a turbine blisk for a high-pressure turbine, where a blade 1 is joined via a welded joint 3 to a disk segment 2.

Depending on the type of engine and the position of the blisk, the design of the blisk may also include a supporting segment, which is also referred to in English as a “shroud” and shown schematically as shroud 5 in FIG. 1. U.S. Pat. No. 5,562,419 describes an example of a compressor blisk that is provided with shrouds.

The European Patent Application EP 1 835 149 A1 describes a device and a method for monitoring the operation of a turbine. For this purpose, temperature sensors are used to monitor a component at various locations with respect to its tensile stress condition. The finite method is used to further process the measured temperatures into a characteristic quantity in order to describe the tensile stress condition.

The U.S. Patent Application 2004/0148129 A1 is concerned with diagnosing a damage condition of a stationary power turbine. The diagnostic accuracy is improved in that both operating information, as well as process information are processed during turbine operation. Operating information is understood to be the service life, in particular.

### SUMMARY OF THE INVENTION

It is an object of the present invention to improve the service-life monitoring during ongoing operation of engines or turbines having a compressor blisk and/or a turbine blisk.

In accordance with a first embodiment, the present invention provides a device for monitoring the service life of an engine or of a turbine having a compressor blisk and/or a turbine blisk. This device has a read-in device for inputting operating parameters measured during the course of engine or turbine operation; a stress calculator for calculating the momentary stresses of substructures of the blisk on the basis of the measured operating parameters; and a damage estimator for estimating the accumulated damage to the individual blisk substructures caused by the momentary stresses, i.e. the stress condition at a given instant of time.

In accordance with a second embodiment of the present invention, a method for monitoring the service life of an engine or a turbine having a blisk is provided. This method includes the steps of measuring the operating parameters in the course of engine or turbine operation, calculating the momentary stresses of substructures of the blisk on the basis of the measured operating parameters, and estimating the accumulated damage to the individual blisk substructures caused by the momentary stresses.

The device according to the present invention and the method according to the present invention are distinguished in that calculations are not only made of the momentary stresses of one single critical part of the blisk, but also of at least two blisk substructures. Moreover, the accumulated damage to the blisk is not estimated as a single total value; rather, the accumulated damage to the individual substructures is estimated. In this manner, it is possible to estimate the potential service life of the individual substructures, making possible a substantially more accurate estimation of the total service life consumption of the blisk.

In the case of the present invention, included among the substructures for which the momentary stresses are calculated, are preferably at least two of the substructures: blade, disk, and, to the extent that it is present, the join region between the blade, disk and shroud. These substructures are subject to greatly varying stress conditions during operation, which is why it is useful to differentiate among the individual stress conditions of these substructures and the individual, thus associated accumulated damage in these substructures.

In the case of the present invention, included among the momentary stress conditions which are calculated, are preferably at least two of the stress conditions: thermomechanical fatigue, creep, low-cycle fatigue, fatigue at high-cycle fatigue, as well as hot-gas corrosion. These stress conditions are the most frequent failure mechanisms that limit the service life of the blisk, which is why it is advisable that they be taken into consideration when calculating the stress conditions and in the subsequent estimation of the accumulated damage.

Finally, damage tolerances are preferably used when estimating damage. This generally known concept provides that any damage that occurred during operation, from which cracks or other defects may arise and which may remain undiscovered for a defined period of time (for example, until the next mandatory scheduled maintenance), be included in the calculation. In other words, a time buffer is included in the calculation to ensure that the blisk is never able to reach the danger zone.

In this manner, the present invention makes it possible for the operating parameters measured during operation to be used to estimate the accumulated damage in the individual substructures of the blisk to enable an individual and risk-minimized utilization of the potential service life of the blisk. This makes it possible to improve the planning of maintenance work and to lower operating costs. Therefore, the device according to the present invention and the method according to the present invention are especially suited for developing an optimized maintenance strategy, which may include both repairing, as well as replacing the damaged blisk.

### BRIEF DESCRIPTION OF THE DRAWING

FIG. 1 is a schematical view of a section of an engine or turbine, in particular the section between a blade and a disk, with the device of the present invention shown schematically.

### DETAILED DESCRIPTION

To illustrate the inventive principle, further details and features of the present invention are described in the following.

In the case of aircraft engines, it turns out that the service life consumption and the damage progression are only roughly dependent on the total flight time. Thus, in particular, the starting and stopping of the engine and individual flight maneuvers, which lead to power peaks during the flight, substantially influence the service life of the individual engine components. A change in the control software or modification to the hardware of the engine may likewise affect the service life. For that reason, it is useful to monitor the service life consumption of the critical components of an engine, for instance, of compressor blisks and turbine blisks, during operation.

Included among the operating parameters of the engine that may be measured during operation, are, in particular, the intake conditions, the rotational speeds, as well as the temperatures and pressures prevailing in the gas channel and the cooling-air channels, via for example intake condition sensors 110, rotational speed sensors 112, temperature sensors 114 and pressure sensors 116.

Among the factors that stress the engine components are, first and foremost, the thermal stresses due to the temperature distribution in the component, and mechanical stresses due to the tensile and compressive forces acting on the component, but also chemical stresses, such as hot-gas corrosion, for example.

When calculating the thermal stress, the temperature distribution in the component is calculated. Based on the initial temperature distribution, which is dependent on the most recent temperature distribution during the previous operational use, the instantaneous ambient temperature, and the time that has elapsed since the most recent operational use, the development of the temperature distribution is calculated over the entire operational use based on the measured operating parameters.

When calculating the mechanical stresses, the acting total load is calculated for each monitored region. The total load is composed of thermal stresses, which are induced by the momentary temperature distribution, the centrifugal stresses, which are derived from the rotational speed, and of additional stresses resulting from the gas pressure, assembly forces, etc.

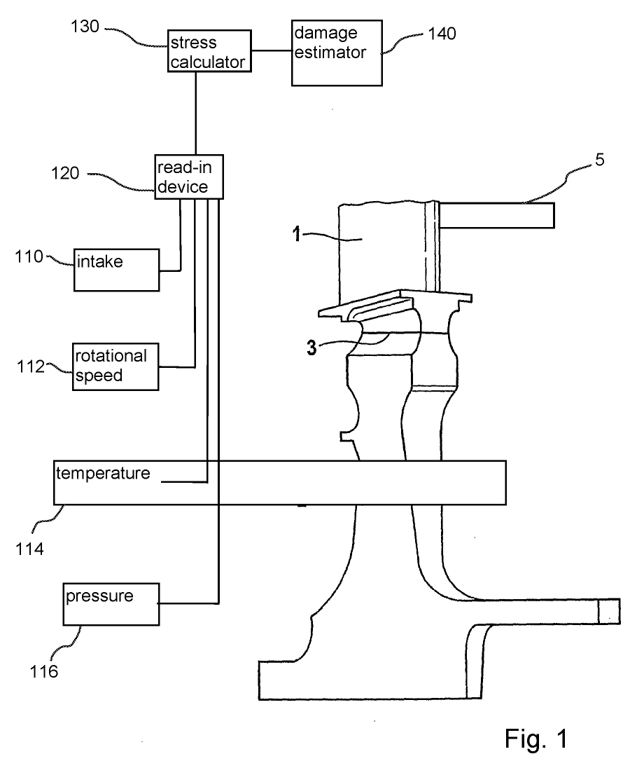

Included among the service life-critical substructures of a compressor disk or turbine blisk are the blades 1 and the disk 2 or disk segments as seen in FIG. 1. Moreover, the join region 3 between the blades 1 and the disk 2 may be critical, particularly in the case of friction-welded blisks, in the case of which the blades 1 and the disk 2 are made of different materials. In the case of blisks having a shroud 5, damage in the shroud may also limit the service life.

The stresses acting on the individual substructures of the blisk are calculated on the basis of algorithms processed in a stress calculator 130 which are fast enough to permit an on-board, real-time calculation. To calculate the stresses acting on the blades, five algorithms are preferably used which calculate the thermomechanical fatigue, creep, low-cycle fatigue, high-cycle fatigue and hot-gas corrosion, respectively. To calculate the stresses acting on the blade and the shroud, two algorithms are preferably used in each case which calculate creep and low-cycle fatigue. To calculate the stresses acting on the join region between the blade and the disk, two algorithms are preferably used which calculate the thermomechanical fatigue and the low-cycle fatigue. Data from sensors 110, 112, 114, 116 for example can be fed via read-in device 120 to stress calculator 130.

The stresses, which are calculated for the individual substructures of the blisk, are subsequently assessed in damage estimator 140 in terms of the relevant damage mechanism with the aid of suitable algorithms in order to estimate on the basis thereof, the added damage that occurs in the substructures during operation. This damage is accumulated with, i.e. added to, the already existing damage in the particular case, so that an increase in service life consumption may be calculated for each substructure relative to the total service life of the sub structure.

The remaining service life of the particular substructure may be estimated from the difference between the potential service life and the service life consumption of the individual substructures. In this context, damage tolerances are preferably used to include a time buffer in the calculation, to ensure that the accumulated damage of the substructures is never able to reach the danger zone before the next maintenance. The remaining service life of the entire blisk is then determined by the remaining service life of the substructure having the highest service life consumption.

A suitable condition-dependent maintenance strategy may then be developed as a function of the remaining service lives calculated in this manner. However, if the service-life monitoring of the blisk reveals that the damage to the blades is already quite advanced, while the service life consumption of the disk is not yet considerable, one possible maintenance strategy could be to replace the blades at the end of their remaining service life, however, to continue to use the disks following a repair or reconditioning. On the other hand, should it turn out that the service-life consumption of the two substructures has advanced to approximately the same level, replacing the complete blisk may be the more economical alternative. In the first case, following the maintenance, only the accumulated damage of the blades would be reset to zero, while the remaining substructures retained their accumulated damage, whereas, in the second case, the accumulated damage of all substructures would be reset to zero.

The result, therefore, is that the service-life monitoring according to the present invention renders possible a blisk maintenance that is better suited for meeting the requirements and is more cost-effective. Moreover, the data acquired from the service-life monitoring may also be used for other purposes, such as for further developing the engine or for adapting the engine hardware and engine software to the individual application prototype of the engine.

It is understood that the service-life monitoring according to the present invention is not only useful for aircraft engines, but also for stationary turbines, such as gas turbines, for example, that are not continuously driven at a constant operating power. Thus, other possible uses and exemplary embodiments that were not explicitly addressed may also fall under the scope of protection of the patent claims.

What is claimed is:

1. A device for monitoring service life of an engine or of a turbine having a blisk, the blisk being a compressor blisk or a turbine blisk, the blisk having blisk substructures including a disk, a blade and a shroud, the blisk being defined as the blade and the disk being formed as one unit, the device comprising:
a read-in device for inputting operating parameters measured during the course of engine or turbine operation;
a stress calculator for calculating momentary stresses of the blisk substructures on the basis of the measured operating parameters, the blisk substructures for which the momentary stresses are calculated including the shroud and the blade; and
a damage estimator for estimating the accumulated damage to the blade and the shroud caused by the momentary stresses.

2. The device as recited in claim 1 wherein the blisk substructures for which the momentary stresses are calculated further include the disk.

3. The device as recited in claim 1 wherein the stress calculator calculates the momentary stresses of at least two of the stress conditions of: creep, low-cycle fatigue, high-cycle fatigue and hot-gas corrosion.

4. The device as recited in claim 3 wherein the stress calculator further calculates the momentary stresses for thermomechanical fatigue.

5. The device as recited in claim 1 wherein the damage estimator operates as a function of damage tolerances.

6. The device as recited in claim 1 wherein the stress calculator calculates momentary stresses at a join region between the blade and the disk.

7. The device as recited in claim 1 wherein the stress calculator calculates momentary stresses at a join region between the blade and the shroud.

8. The device as recited in claim 1 wherein the blades of the blisk are machined from an outer contour of a forged disk segment to define the blades and the disk.

9. The device as recited in claim 1 wherein the blades are friction welded to the disk.

10. A method for monitoring the service life of an engine or of a turbine having blisk, the blisk being a compressor blisk or a turbine blisk having blisk substructures, the blisk substructures including a disk, a blade and a shroud, the blisk being defined as the blade and the disk being formed as one unit, the method comprising the steps of:
measuring the operating parameters in the course of engine or turbine operation;
calculating the momentary stresses of the blade and the shroud on the basis of the measured operating parameters;
estimating accumulated damage to the blade and the shroud caused by the momentary stresses.

11. The method as recited in claim 10 further comprising calculating momentary stresses on the disk.

12. The method as recited in claim 10 wherein momentary stresses are calculated for of at least two of the stress conditions of: creep, low-cycle fatigue, high-cycle fatigue and hot-gas corrosion.

13. The method as recited in claim 12 wherein the momentary stresses for thermomechanical fatigue are also calculated.

14. The method as recited in claim 10 wherein the accumulated damage is estimated as a function of damage tolerances.

15. The method as recited in claim 10 further comprising developing a maintenance strategy as a function of the estimated accumulated damage.

16. The method as recited in claim 10 further comprising calculating momentary stresses at a join region between the blade and the disk.

17. The method as recited in claim 10 further comprising calculating momentary stresses at a join region between the blade and the shroud.

18. The method as recited in claim 10 wherein the blades of the blisk are machined from an outer contour of a forged disk segment to define the blades and the disk.

19. The device as recited in claim 10 wherein the blades are friction welded to the disk.

20. A method for using the device as recited in claim 1 comprising: developing a maintenance strategy as a function of an output of the damage estimator.
